(19) United States
(12) Patent Application Publication
(10) Pub. No.: US 2003/0107161 A1
(43) Pub. Date: Jun. 12, 2003

(54) Spring suspension device

(76) Inventors: Martin Teichmann, Graz (AT); Gerhard Kaserer, Gratkorn (AT); Herwig Waltensdorfer, Graz (AT)

Correspondence Address: SUTHERLAND ASBILL & BRENNAN LLP, 999 PEACHTREE STREET, N.E., ATLANTA, GA, 30309, US

(21) Appl. No.: 10/316,712

(22) Filed: Dec. 11, 2002

(30) Foreign Application Priority Data
Dec. 11, 2001 (AT) A 1937/2001

(51) Int. Cl. F16F 5/00

(52) U.S. Cl. 267/64.11; 267/34

(57) ABSTRACT

A spring suspension device is provided for rail vehicles which is arranged in the region of the wheels in the form of a primary spring suspension between the wheel axle and a frame and/or in the form of a secondary spring suspension between the frame and the vehicle box body, wherein the spring suspension device includes at least one main spring and at least one auxiliary spring device assigned to the main spring, and wherein the at least one main spring comprises a hydropneumatic spring arranged in series with the auxiliary spring device. The auxiliary spring device is, for example, realized in the form of a coil spring. In a spring suspension system for a rail vehicle in which several such spring suspension devices are used, two or more hydraulic units of the hydropneumatic springs may be connected to a common gas reservoir by means of a synchronization unit.

### CROSS-REFERENCE TO RELATED APPLICATIONS

Priority is claimed under 35 U.S.C. 119 to Austrian patent application A 1937/2001, filed Dec. 11, 2001.

### FIELD OF THE INVENTION

The invention pertains to a spring suspension device for rail vehicles which is arranged in the region of the wheels in the form of a primary spring suspension between the wheel axle and a frame and/or in the form of a secondary spring suspension between the frame and the vehicle box body, wherein the spring suspension device consists of at least one main spring and at least one auxiliary spring device assigned to the main spring.

### BACKGROUND OF THE INVENTION

Spring suspension devices, for example, in an axle spring suspension, serve for supporting the vehicle body relative to the axles. The spring suspension is, among other things, used for increasing the riding comfort, the service life and the riding safety, with the spring suspension simultaneously compensating the static over-rigidity of the wheels. The spring suspension isolates the body from high-frequency vibrations of the wheels, and the body should follow the wheels on long-wave roadway contours.

In rail vehicles, in particular, the requirements with respect to the spring suspension devices continue to increase. However, the available structural space simultaneously becomes smaller and smaller. It is very difficult to manage this conflict with conventional spring suspensions currently available on the market.

The special requirements with respect to spring suspensions pertain, in particular, to a high load, higher limiting speeds at which the vehicle begins to become unstable, an adequate rolling stability, a long spring travel, as well as a low, progressive vertical stiffness of the spring suspension. In addition, a load-independent position of the upper floor edge (UFE), for example, in rail vehicles for passenger transport, as well as a defined lateral stiffness, would also be desirable.

Pneumatic springs with a serial emergency spring are currently utilized in connection with roll stabilizers, for example, in the form of torsion bars. However, the relatively low air pressure in the pneumatic springs which can be realized in practical applications requires a large effective diameter of the springs. This frequently leads to problems with the available structural space.

Progressive coil or rubber springs are also utilized for this purpose; however, these springs cannot fulfill the requirement with respect to a load-independent UFE.

Hydropneumatic springs of adjustable height are also utilized in combination with prestressed emergency springs arranged parallel thereto. However, the existing spring travel cannot be optimally utilized in this fashion such that a higher stiffness of the emergency spring is also required in this case.

### SUMMARY OF THE INVENTION

The invention is based on the objective of developing a spring suspension device that has a progressive spring characteristics, allows a load-independent positioning of the UFE and does not require a high vertical stiffness of the springs used.

In a spring suspension device of the initially described type, this objective is, according to the invention, attained due to the fact that the at least one main spring consists of a hydropneumatic spring that is arranged in series with the auxiliary spring device.

Since the main spring consists of a hydropneumatic spring that represents a progressive spring due to its basic progression of the spring characteristic, the position of the UFE can be adjusted independently of the load by pumping in additional hydraulic fluid. In contrast to conventional spring suspensions in which only the main spring exerts the actual spring energy in the “normal mode” and the auxiliary spring strictly serves as an emergency spring that only becomes effective when the main spring fails, the serial arrangement of the springs in accordance with the invention also causes the auxiliary spring or the auxiliary spring system to exert spring energy. The serial arrangement makes it possible to achieve low total vertical stiffness of the spring suspension device.

In order to prevent the spring suspension from bottoming, in particular, in the emergency or auxiliary spring mode, it is practical if the auxiliary spring device has a spring characteristic with a progressive limit stop.

According to a first embodiment, the auxiliary spring device comprises at least one rubber spring.

In another embodiment of the invention, the auxiliary spring device comprises at least one coil spring.

Naturally, it is also possible that the auxiliary spring device consist of a rubber spring/coil spring combination.

In one concrete, tested embodiment of the invention, the hydropneumatic spring essentially consists of an end piece that is connected to a piston, wherein the piston can be displaced in a cylinder, and wherein a hydraulic volume limited by the piston and the cylinder changes when the piston is displaced.

With respect to the available structural space and the simple handling of the hydropneumatic spring, it is advantageous if at least one hydraulic line that connects the hydraulic volume to a gas reservoir extends through the piston. In this case, the lines are usually realized in the form of bores in the cylinder. It is particularly advantageous that two or even more lines (bores) extend through the piston because the lines and the working volume can be flushed in this fashion.

In one tested embodiment, the end piece of the hydropneumatic spring is situated in an upper position and the hydraulic volume is situated in a lower position in the installed state, wherein the gas reservoir is arranged in the region of the upper end piece. This arrangement makes it possible to realize a solid pipe connection with the gas reservoir. In contrast to a hose connection with the gas reservoir as would be required in an arrangement in the lower region due to movement of the gas reservoir relative to the remainder of the hydropneumatic spring, a pipe connection is significantly more stable and less susceptible to damage.

It is advantageous if the hydropneumatic spring is connected to the auxiliary spring device by means of a connecting element. This makes it possible to easily separate both springs from one another. If the individual components have a different service life, this measure makes it possible to merely remove one of the components and not the entire spring suspension device. This measure also simplifies the maintenance procedures because only one spring needs to be removed and not the entire spring suspension device.

In one concrete embodiment, the connecting element contains a receptacle for the cylinder of the hydropneumatic spring, into which the cylinder is fitted. In this embodiment, it is, in principle, possible to utilize an arbitrary hydropneumatic spring, wherein it is merely required to adapt the connecting element to the hydropneumatic main spring.

In another advantageous embodiment, the connecting element contains a cylindrical opening for the piston. In this case, the connecting element practically represents part of the hydropneumatic spring such that an additional cylinder, in which the piston can be displaced, is no longer required. This embodiment is particularly advantageous because the invention can be realized with a smaller number of components.

The cylinder of the hydropneumatic spring is—independently of the fact whether it is realized integrally with or separately from the connecting element—sealed in an upper region with a cylinder head (plunger design). This eliminates the need for a seal of the piston relative to the cylinder wall such that the spring effect is not impaired by additional friction.

In one particularly space-saving design of the invention, the auxiliary spring device consists of a coil spring, and at least certain regions of the connecting element and the hydropneumatic spring are arranged in the interior of the coil spring.

In this case, the connecting element rests on an upper region of the coil spring.

In order to secure the connecting element from laterally sliding on the coil spring, at least certain regions of the connecting element contain downwardly protruding extensions in the contact zone.

In another embodiment, the auxiliary spring device is realized in the form of a rubber spring that contains an opening, into which at least certain regions of the connecting element with the hydropneumatic spring are fitted. For example, this opening has a cylindrical shape, and the connecting element is centrally fitted into this cylindrical opening, wherein said opening contains an end face stopping surface in the upper region so as to prevent the connecting element from sliding through the opening.

In one particularly advantageous embodiment of the auxiliary rubber spring, the opening has a conical shape with a downwardly tapered cross section. In this case, the connecting element is prevented from sliding downward without additional measures, and a stable seat of the connecting element is ensured.

The spring suspension device can be reliably prevented from bottoming if the auxiliary spring device contains a limit stop in the form of a rubber buffer in its lower region.

In order to achieve a lateral spring effect, the spring suspension device also comprises at least one lateral spring that, for example, is realized in the form of a rubber spring. The separation of the springs with respect to a horizontal and a vertical spring effect provides the advantage that the dimensions of the springs which define their stiffness can practically be chosen independently of one another.

The invention also pertains to a spring suspension system for a rail vehicle in which at least one of the above-described spring suspension devices is respectively arranged in the region of the wheels as a primary spring suspension between the wheel axle and a frame and/or as a secondary spring suspension between the frame and the vehicle box body, wherein two or more hydraulic units of hydropneumatic springs of the spring suspension devices are connected to a common gas reservoir by means of a synchronization unit. Hydraulic units that are connected to a common gas reservoir by means of a synchronization unit make it possible to achieve a uniform spring deflection, namely also under an uneven load, such that undesirable vehicle motions, e.g., rolling or pitching, can be stabilized independently of dipping motions of the vehicle without requiring additional roll stabilizers or the like.

In one particularly simple and inexpensive design of the spring suspension device, the synchronization unit contains a hollow space that is divided into at least three independent divisional hollow spaces by means of a freely displaceable piston, wherein at least one of these divisional hollow spaces is connected to a gas reservoir and at least two of the other divisional hollow spaces are respectively connected to at least one hydraulic unit of a spring element.

In order to stabilize the vehicle against rolling, it is advantageous if hydraulic units on opposite sides of a wheel axle are connected to a common gas reservoir by means of a synchronization unit.

In rail vehicles that are only subjected to low acceleration or deceleration forces, it is practical if the hydraulic units on one side of the vehicle are connected to one another via a common line and both lines of the respective vehicle sides are connected to a gas reservoir by means of a common synchronization unit. This is particularly advantageous because a rolling motion can be absorbed by the springs independently of dipping motions in a simple constructive fashion.

In order to stabilize pitching motions in addition to rolling motions, it is required to respectively connect two hydraulic units arranged on diagonally opposite wheels to a common gas reservoir by means of one respective synchronization unit. In this type of connection, the undercarriage also remains flexible. This is advantageous with respect to frequently occurring twisted rails.

It may also be advantageous if each hydraulic unit is provided with a gas reservoir. This arrangement makes it possible to separately support all wheels of an undercarriage or a vehicle. However, a stabilization of rolling or pitching motions of the vehicle is not possible in this case without additional stabilizing devices.

In this case, the respective working volumes of the hydraulic units are usually connected to one another.

### BRIEF DESCRIPTION OF THE DRAWINGS

The figures show:

FIG. 1, a basic serial arrangement of a hydropneumatic spring and an auxiliary spring in accordance with the invention;

FIG. 2, an embodiment of a spring suspension device according to the invention with a hydropneumatic spring arranged in series with a coil spring;

FIG. 3, another embodiment of a spring suspension device according to the invention with a hydropneumatic spring arranged in series with a rubber spring;

FIG. 4, a basic example of the arrangement of a spring suspension device according to the invention on a rail vehicle;

FIGS. 5-7, schematic representations of the connections between the hydropneumatic springs of several spring suspension devices according to the invention, and

FIG. 8, the schematic design of a synchronization unit.

### DETAILED DESCRIPTION OF THE INVENTION

The invention is described in greater detail below with reference to the figures.

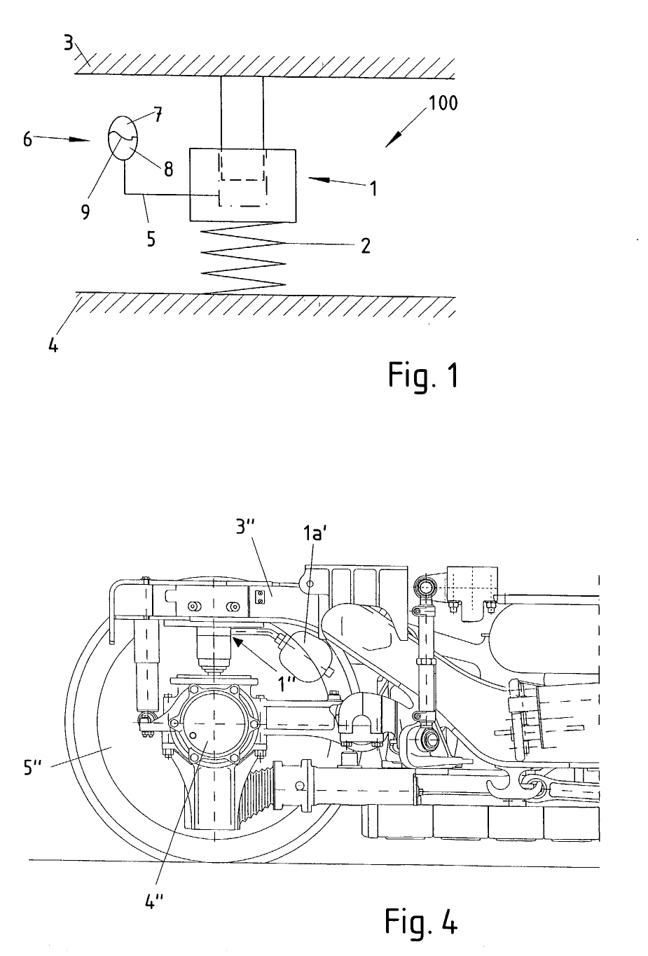

FIG. 1 shows a schematic representation of a spring suspension device 100 according to invention in which a hydropneumatic spring 1 and an auxiliary spring 2 that is realized in the form of a coil spring are connected to one another in the form of a serial arrangement. This spring suspension device 100 is arranged between two elements 3, 4 that can be moved relative to one another, for example, between a vehicle box body and a wheelset. The hydropneumatic spring 1 is conventionally connected to a gas reservoir 6 via a hydraulic line 5, wherein the gas reservoir 6 is divided into a gas chamber 7 and a hydraulic chamber 8 by means of a separating element 9 as schematically indicated in this figure.

In comparison with a spring suspension device in which a main spring is arranged parallel to an auxiliary spring, this arrangement provides a few significant advantages that, among other things, are described below.

The hydropneumatic spring has a progressive spring characteristic in the vertical direction, i.e., a load-dependent spring characteristic. This means that the available structural space can be optimally utilized. A height control can be achieved by pumping additional hydraulic fluid, for example, oil, into the hydraulic circuit of the hydropneumatic spring such that the UFE can be maintained at a constant level independently of the load.

The working medium or power transfer medium consists of a hydraulic fluid, usually oil. These incompressible fluids can be used under high pressures such that the dimensions of the spring suspension device can be maintained comparatively small with respect to required structural space. However, gas is primarily utilized as the hydraulic medium because it is compressible and has a progressive characteristic, with gas also ensuring that the spring travel is optimally utilized.

Due to the progressive characteristic of the hydropneumatic spring 1, it is possible to utilize springs with a lower vertical stiffness than those used in conventional arrangements. Consequently, an improved safety against derailing and a superior riding comfort are achieved.

The lowered rolling stability of the spring suspension device 1 associated therewith can be compensated by interconnecting several hydropneumatic springs on a rail vehicle, e.g., a rail car. This is, for example, described in greater detail in EP 1 029 764 A2 by the applicant and in the following portion of the description.

It would, in principle, be possible to utilize roll stabilizers to prevent undesirable rolling motions. However, this means that the auxiliary spring(s) need to have a correspondingly lower vertical stiffness in order to compensate the stiffness of the roll stabilizers; however, this usually results in the auxiliary springs becoming excessively soft. This is disadvantageous and undesirable with respect to the emergency spring mode. It is much more favorable to interconnect several hydropneumatic springs because the rolling forces are absorbed by the hydraulic medium in this case. The maximum attainable rolling stiffness is, in case of a main spring failure, defined by the serially connected auxiliary spring 2. If a rolling stiffness that is even lower than those conventionally attainable needs to be realized, it is possible to install one or more additional rolling cavities in the hydraulic system, into which hydraulic fluid is able to correspondingly flow.

A vertical dampening of the spring suspension device can also be achieved in conventional fashion by throttling the hydraulic flow.

Due to the serial arrangement, the auxiliary spring 2 is always prestressed in accordance with the current load status such that no vertical spring travel is unnecessarily wasted by additionally prestressing the auxiliary spring as is the case in parallel systems. This means that the auxiliary spring 2 can be realized with a lower vertical stiffness such that an improved safety against derailing is also achieved in case the main spring 1 fails, i.e., in the auxiliary or emergency spring mode.

In contrast to parallel spring arrangements, the serial auxiliary spring 2 also exerts part of the spring energy in the normal mode, and low total stiffness can be achieved by means of a corresponding stiffness distribution over the individual springs in a spring suspension device.

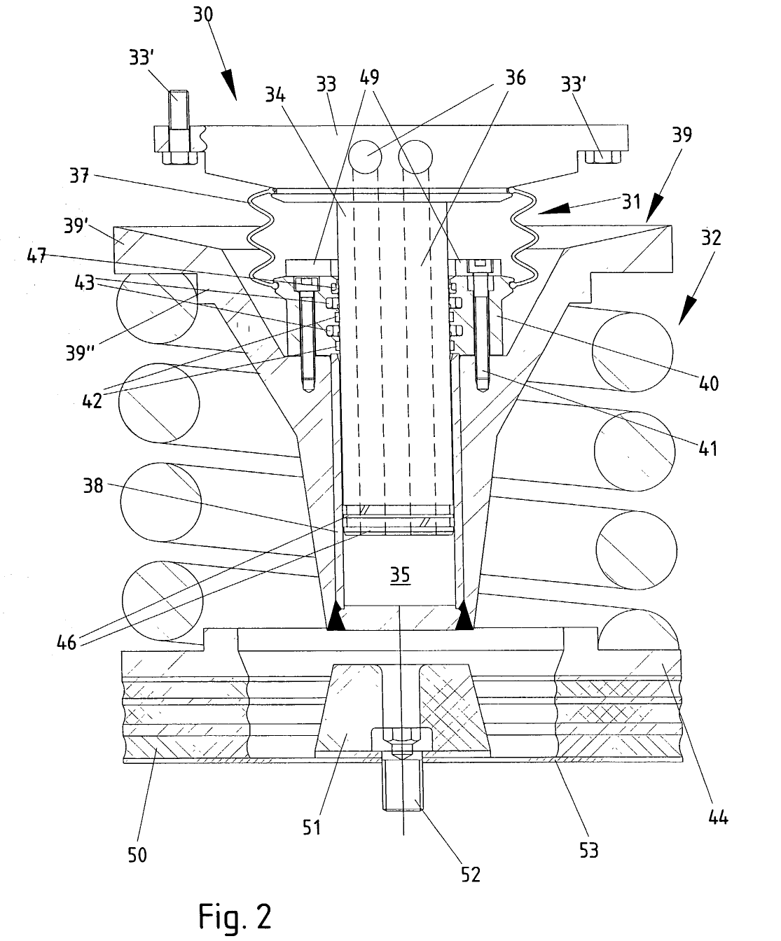

FIG. 2 shows a first concrete embodiment of a spring suspension device 30 according to the invention which consists of a hydropneumatic main spring 31 and an auxiliary spring 32 that is arranged in series with the main spring and realized in the form of a coil spring in this embodiment. In its upper region, the hydropneumatic spring 31 contains an end piece 33 that is connected to, for example, a vehicle box body by means of mounting elements 33′, e.g., screws or bolts.

The end piece 33 is connected to a piston 34 that can be vertically displaced in a cylinder 38 such that a volume 35 in the cylinder 38 which is filled with a hydraulic fluid, for example, oil—and also referred to as the working volume below—can be varied. This hydraulic volume 35 is connected to one—or more—gas reservoir(s) that is/are not illustrated in the figure via hydraulic lines 36, in this case, two hydraulic lines. Such a gas reservoir is, for example, divided into a gas chamber and a hydraulic chamber by means of a separating element realized in the form of a membrane. It would, in principle, also be possible to provide only one hydraulic line 36, with two or more lines providing the advantage that the volume 35 can be flushed.

The piston 34 is preferably realized in the form of a piston rod that contains guide bands 46 in its lower region and that is situated in the cylinder 38. The piston 34 is not sealed relative to the cylinder 38 such that disadvantageous friction is also prevented at this location.

In order to protect the piston rod 34 from becoming soiled and dirt from being admitted into the hydraulic volume 35, the upper region of the piston rod which protrudes out of the cylinder 35 is surrounded by a bellows 37. The bellows 37 is connected in a sealed fashion to the end piece 33 with its upper region and analogously connected to a cylinder head 40 on its lower end. The piston rod 34 is sealed relative to the cylinder 38 with the cylinder head 40. For this purpose, the cylinder head 40 contains guide rings 42, as well as ring seals 43 for the piston rod 34. A dirt stripper 47 is provided above the ring seals and guide rings such that any dirt on the piston rod 34 is stripped off by this dirt stripper.

The arrangement of the seal in an upper region provides the particular advantage that any dirt moves downward, i.e., away from the seal, such that its function is not impaired by the dirt.

The cylinder head 40 is rigidly connected to a connecting element 39 by means of fastening means 41, for example, screws. This connecting element rests on the uppermost turn of the coil spring 32 with upper regions 39′. The installation height of the cylinder 40 can be influenced with shims 49 and thusly adapted, for example, to the wear of the wheel as part of vehicle maintenance procedures.

The connecting element 35 has, for example, a cylindrical or a conical shape. However, the shape can be chosen arbitrarily, with the connecting element usually consisting of a metal. In its upper region 39′, the connecting element is provided with a downwardly directed peripheral projection 39″ for securing the connecting element from laterally sliding on the coil spring 32.

During a spring deflection, for example, the force acting upon the hydropneumatic spring, i.e., onto the end piece 33, is transferred onto the connecting element 39 by means of the piston 34 and subsequently by the guide rings 42, as well as the cylinder head 40, and then transferred from the connecting element onto the coil spring 32.

The connecting element 35 may also be rigidly connected to the coil spring 32 with respect to vertical motions. However, this is not absolutely necessary because the hydropneumatic spring 31 can only be subjected to pressure and therefore the spring 31 and the connecting element 35 cannot lift off the coil spring.

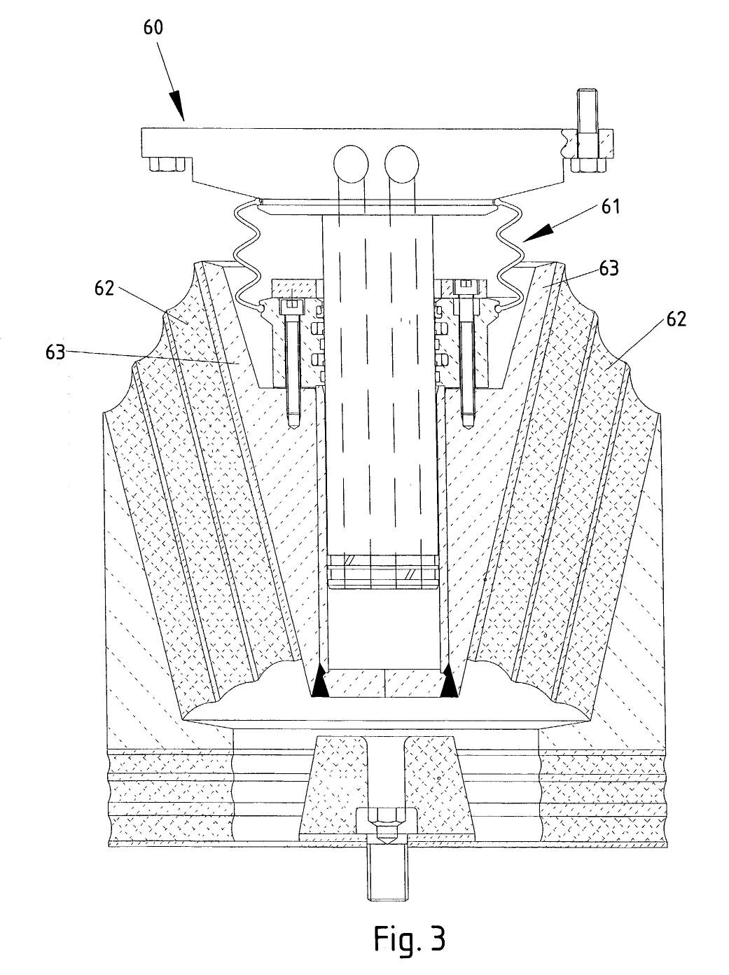

In FIG. 2 and in FIG. 3, the hydropneumatic spring and the connecting element 39 are realized separately, wherein the connecting element accommodates the cylinder 38, in which the piston 34 can be displaced. In another advantageous embodiment that is not illustrated in the figures, the cylinder 38 and the connecting element 39 are not realized separately, wherein the connecting element contains a cylindrical recess in which the piston 34 can be displaced, and wherein this recess also limits the working volume in this case except for the upper side that is limited by the piston 34. In this particular design, the connecting element 39 naturally represents an integral component of the hydropneumatic spring.

In its lower region, the coil spring 32 rests on a connecting plate 44, wherein said connecting plate contains depressions that are adapted to the turns of the spring 32. On its underside, the connecting element 44 is connected to a lateral spring 50 that serves as a lateral spring suspension. This lateral spring usually consists of one or more rubber springs.

However, a connecting element 44 as shown in the figure may also be omitted, in which case the spring 32 simply rests in depressions of the rubber spring 50.

A rubber buffer 51, on which the connecting cylinder 35 impacts under very high loads, is also provided. This makes it possible to prevent bottoming of the spring suspension because the rubber buffer 51 can be realized very rigidly in the vertical direction and a very progressive spring characteristic of the spring suspension device 30 can be achieved in this fashion in case of bottoming. It is thus possible that the rubber buffer 51 merely serves as a limit stop or that the rubber buffer 51 already exerts part of the spring energy in the auxiliary spring mode.

A connecting means 52 that consists of a screw or a bolt is also shown, wherein said connecting means serves for rigidly connecting the spring suspension device to, for example, a wheelset as schematically illustrated in FIG. 4. According to FIG. 2 and FIG. 3, the lateral spring 50 is provided with a sheet metal plate 53 on its underside in this case, wherein said sheet metal plate is, for example, vulcanized onto the lateral spring.

FIG. 3 shows another embodiment of a spring suspension device 60 according to the invention which also consists of a hydropneumatic spring 61 that has the same design as the hydropneumatic spring shown in FIG. 2 and consequently is not described in greater detail anew, as well as an auxiliary spring 62 that is realized in the form of a rubber spring and acts in the vertical direction. The hydropneumatic spring 61 is serially connected to the rubber spring 62 by means of a connecting element 63—that may form an integral component of the hydropneumatic spring 61 as described above. According to this figure, the rubber spring 62 contains a conical recess in its interior, wherein the cross section of this conical recess is downwardly tapered. The connecting element 63 has a corresponding outside contour such that it merely needs to be “inserted” into this recess in the rubber spring 62 together with the hydropneumatic spring 61; additional mounting elements may be provided, but are not absolutely necessary because the spring suspension device can only be subjected to pressure as described above. The remaining design of this embodiment is identical to that shown in FIG. 2 and consequently not described in detail anew.

The recess in the rubber spring 62 may, for example, also be realized cylindrically, wherein the connecting element is centrally fitted into this recess. The connecting element 63 is, for example, provided with end face stopping surfaces such that it is secured from sliding through the rubber spring.

FIGS. 2 and 3 clearly show that the main spring and the auxiliary spring are arranged in series, wherein the connection is realized with a connecting element that, under certain circumstances, may form an integral component of the hydropneumatic spring as described above. The available structural space can be optimally utilized due to the arrangement of the hydropneumatic spring 31, 61 in the interior of the coil spring 32 or the rubber spring 62, wherein a very long spring travel can be achieved in comparison with existing spring suspension devices.

The hydropneumatic spring and the auxiliary spring can be easily separated from one another such that an individual component of the spring suspension device can be easily exchanged.

The interconnection of the spring suspension devices according to the invention or the hydropneumatic springs of these devices, i.e., their hydraulic units and working volumes, in a spring suspension system consisting of several such spring suspension devices—which was already mentioned above—is described in greater detail below. The term hydraulic unit refers to the entire region of the hydropneumatic spring which consists of the working volume of the spring, the hydraulic chamber in the gas reservoir and the connections between these regions. In this case, the working volumes 35 of different spring suspension devices are usually connected to one another, but it would, in principle, also be possible to interconnect the hydraulic chambers in the gas reservoir.

FIG. 4 shows an undercarriage frame 3″, a wheelset bearing 4″ and a wheel 5″ of a rail vehicle. The installation of a spring suspension device 1″ between the undercarriage frame 3″ and the wheelset bearing 4″ is schematically indicated in this figure, wherein a gas reservoir 1a″ is also shown. In one practical embodiment, the spring suspension device 1″ is, although it only needs to transmit compressive forces, connected to the undercarriage frame 3″ and to the housing of the wheelset bearing 4″ by means of screws.

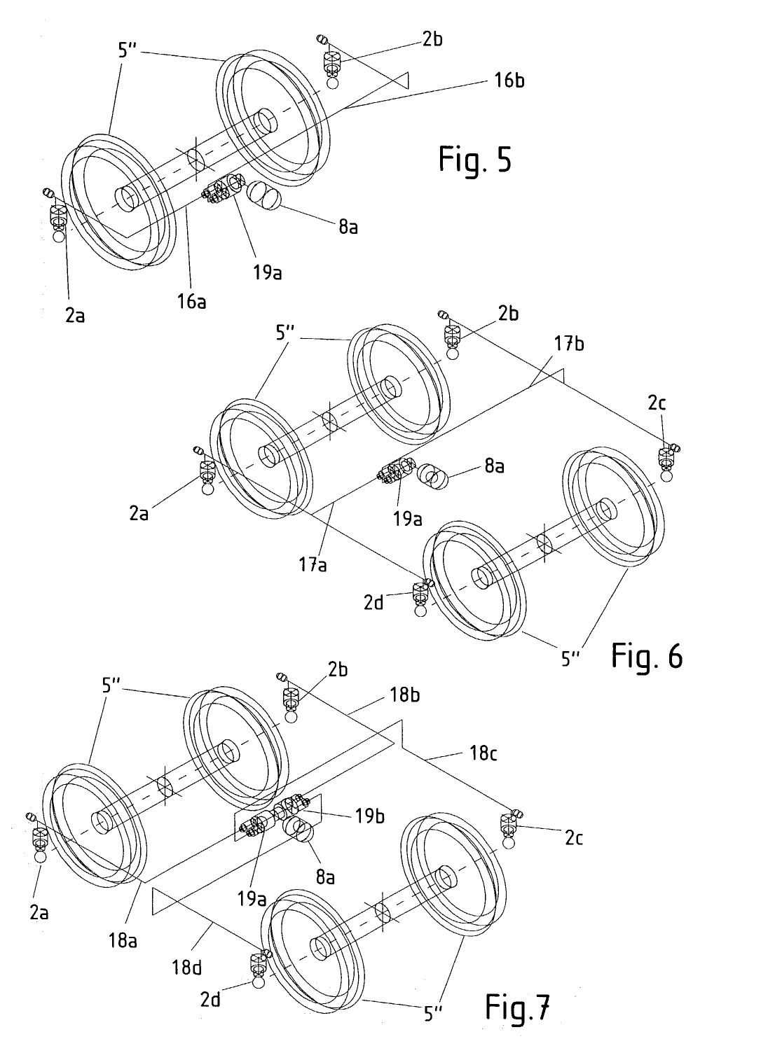

FIGS. 5-7 show highly schematic spring systems, in which the hydraulic units 2a-2d of spring suspension devices are arranged in the region of wheels 5″ of a rail vehicle. In this case, the working volumes of the hydraulic units are logically interconnected. These figures do not show the above-mentioned embodiment in which each working volume is provided with its own gas reservoir, i.e., an embodiment in which the hydraulic units are not interconnected. Although this embodiment allows a separate spring suspension for each wheel, pitching or rolling motions cannot be stabilized independently of dipping motions without an additional stabilizing device in this case.

FIG. 5 shows a spring suspension system in greater detail, wherein a rolling motion of the vehicle is largely suppressed due to the fact that the working volumes of two hydraulic units 2a and 2b arranged in the region of wheels 5″ on opposite sides of an axle are connected to a common gas reservoir 8a via lines 16a and 16b, as well as a synchronization unit 19a. The synchronization unit 19a, the function of which is described in greater detail below, serves for connecting the—in this case two—working volumes in such a way that a spring deflection of one spring suspension device directly leads to a spring deflection of the spring suspension device coupled thereto or, more specifically, to a spring deflection of the interconnected hydraulic units 2a and 2b such that a rolling motion is prevented. In order to sufficiently absorb rolling motions, it goes without saying that this interconnection of oppositely arranged hydraulic units needs to be realized on each axle.

FIG. 6 also shows a spring suspension system for stabilizing rolling motions of a rail vehicle. In this embodiment, the working volumes of hydraulic units 2a and 2d, as well as 2b and 2c, on the respective sides of the vehicle are interconnected via common lines 17a and 17b. However, the hydraulic units of one side are not connected to one another by means of a synchronization unit. In this case, the respectively interconnected hydraulic units on one side of the vehicle and the interconnected hydraulic units on the other side of the vehicle are connected to a common gas reservoir 8a by means of a synchronization unit 19a. The vehicle is stabilized against rolling motions with this simple interconnection of the working volumes of four hydraulic units 2a-2d. However, this roll stabilization with only one synchronization unit 19a is only suitable for vehicles that are subjected to low acceleration and deceleration forces because a pitching motion cannot be absorbed in this embodiment. The interconnections of the hydraulic units or working volumes which are illustrated in FIG. 5 and FIG. 6 may be analogously applied to rail vehicles with more than two axles.

One problem with respect to rail vehicles can be seen in the fact that twisted rails occur along a track. If the spring suspension is excessively stiff, this leads to a load alleviation on at least one of the wheels of the undercarriage. If an excessively high load alleviation occurs, it is, under certain circumstances, possible for the vehicle to derail. This problem can be solved with the interconnection of the working volumes of hydraulic units shown in FIG. 7. In this embodiment, diagonally opposite hydraulic units 2a and 2c, as well as 2b and 2d, are respectively connected to a common gas reservoir 8a via lines 18a, 18c, as well as 18b and 18d, and via synchronization units 19a, 19b. This interconnection of the working volumes not only makes it possible to absorb rolling and pitching motions, but the vehicle or the undercarriage is also elastic such that an excessive load alleviation of a wheel can be prevented independently of the chosen spring stiffness and consequently independently of the spring suspension of dipping motions.

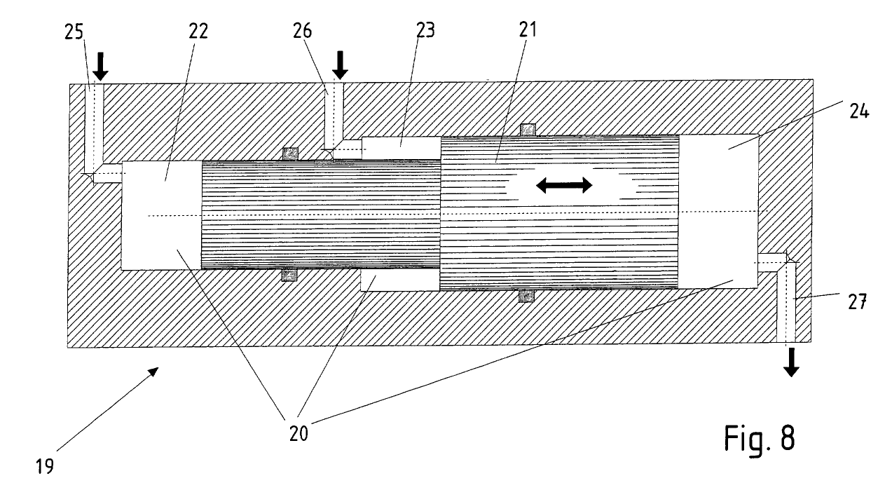

The functional principle of a synchronization unit 19 which was already mentioned above with reference to FIGS. 5-7 is described below with reference to FIG. 8. FIG. 8 shows a synchronization unit 19 for two working volumes or hydraulic units of hydropneumatic springs of a spring suspension device according to the invention. However, the following description naturally applies analogously to an embodiment of the synchronization unit for more than two working volumes.

FIG. 8 shows that a hollow space 20 is divided into three independent divisional hollow spaces 22-24 by a freely displaceable piston 21. The divisional hollow spaces 22 and 23 are connected to the working volumes of two hydraulic units via lines 25 and 26, and the divisional hollow space 24 is connected to the hydraulic chamber of a gas reservoir via a line 27. The hydraulic units, as well as the gas reservoir, are not shown in this figure. A compression of the hydropneumatic spring under the influence of a force causes the thusly displaced volume to flow into a divisional hollow space of the synchronization unit 19, for example, the divisional hollow space 22. This causes the piston 21 to be displaced in accordance with the volume displaced in the divisional hollow space 22 such that the volume in the divisional hollow space 24 is reduced because the hydraulic fluid contained therein flows into the connected hydraulic chamber of the gas reservoir via the line 27. The volume of the divisional hollow space 23 is simultaneously increased. Due to the larger available volume in the divisional hollow space 23, hydraulic fluid is able to flow out of the working volume of the hydraulic unit that is connected to the synchronization unit 19 via the line 26. This leads to a corresponding spring deflection of this spring suspension device or hydraulic unit although the external force acting upon this hydraulic unit is lower than that acting upon the hydraulic unit connected to the synchronization unit 19 via the line 25.

This simply constructed synchronization unit 19 makes it possible to interconnect the working volumes of two are more hydraulic units in such a way that a uniform spring deflection of all spring elements is achieved despite an uneven load. Consequently, a pitch and/or roll stabilization can be achieved independently of the vertical stiffness of the spring elements by suitably interconnecting the working volumes, with no additional mechanical stabilizing devices being required in this case.

Naturally, the function of the described synchronization unit may, as described above, be expanded to several working volumes of several spring elements or hydraulic units, respectively.

The various interconnecting options for hydraulic units mounted in the region of wheels were described on the example of two-axle vehicles or undercarriages because these arrangements are most frequently utilized in rail vehicles. However, these options can also be utilized in rail vehicles with a three or more axles and apply analogously.

It should also be mentioned that the fluid flows in the spring elements and lines may be dampened by means of throttling devices. This eliminates the need for the installation of additional dampers provided independently of the springs. This measure also provides advantages with respect to the small available structural space and the costs and thusly contributes to a weight reduction of the rail vehicle.

In addition, a height control realized by means of a pump and a height controller may be provided. This height control makes it possible to achieve a constant height of the vehicle box body independently of the load.

We claim:

1. A spring suspension device for rail vehicles which is arranged in the region of the wheels in the form of a primary spring suspension between the wheel axle and a frame and/or in the form of a secondary spring suspension between the frame and the vehicle box body, the spring suspension device comprising:
at least one main spring; and
at least one auxiliary spring device assigned to the main spring,
wherein the at least one main spring comprises a hydropneumatic spring that is arranged in series with the auxiliary spring device.

2. The spring suspension device of claim 1, wherein the auxiliary spring device has a spring characteristic with a progressive limit stop.

3. The spring suspension device of claim 1, wherein the auxiliary spring device comprises at least one rubber spring.

4. The spring suspension device of claim 1, wherein the auxiliary spring device comprises at least one coil spring.

5. The spring suspension device of claim 1, wherein the auxiliary spring device comprises a rubber spring/coil spring combination.

6. The spring suspension device of claim 1, wherein the hydropneumatic spring comprises an end piece that is connected to a piston, wherein the piston can be displaced in a cylinder, and wherein a hydraulic volume limited by the piston and the cylinder changes when the piston is displaced.

7. The spring suspension device of claim 6, wherein at least one hydraulic line that connects the hydraulic volume to a gas reservoir extends through the piston.

8. The spring suspension device of claim 7, wherein the end piece of the hydropneumatic spring is situated in an upper position and the hydraulic volume is situated in a lower position in the installed state, and by the fact that the gas reservoir is arranged in the region of the upper end piece.

9. The spring suspension device of claim 1, wherein the hydropneumatic spring is connected to the auxiliary spring device by means of a connecting element.

10. The spring suspension device of claim 9, wherein the connecting element contains a receptacle for the cylinder of the hydropneumatic spring, wherein the cylinder is fitted into said receptacle.

11. The spring suspension device of claim 6, wherein the connecting element contains a cylindrical opening for the piston.

12. The spring suspension device of claim 6, wherein the cylinder of the hydropneumatic spring is sealed in an upper region with a cylinder head.

13. The spring suspension device of claim 9, wherein the auxiliary spring device comprises a coil spring, and at least certain regions of the connecting element with the hydropneumatic spring are arranged in the interior of the coil spring.

14. The spring suspension device of claim 13, wherein the connecting element rests on an upper region of the coil spring.

15. The spring suspension device of claim 14, wherein at least certain regions of the connecting element contain downwardly protruding extensions in the contact zone.

16. The spring suspension device of claim 9, wherein the auxiliary spring device is in the form of a rubber spring with an opening, into which at least certain regions of the connecting element and the hydropneumatic spring are fitted.

17. The spring suspension device of claim 16, wherein the opening has a conical shape with a downwardly tapered cross section.

18. The spring suspension device of claim 1, wherein the auxiliary spring device contains a limit stop in the form of a rubber buffer in its lower region.

19. The spring suspension device of claim 1, further comprising at least one lateral spring.

20. The spring suspension device of claim 19, wherein the at least one lateral spring is in the form of a rubber spring.

21. A spring suspension system for a rail vehicle in which at least one spring suspension device of claim 1 is provided in the region of the wheels in the form of a primary spring suspension between the wheel axle and a frame and/or in the form of a secondary spring suspension between the frame and the vehicle box body, wherein two or more hydraulic units of hydropneumatic springs of the spring suspension devices are connected to a common gas reservoir by means of a synchronization unit.

22. The spring suspension system of claim 21, wherein the synchronization unit contains a hollow space that is separated into at least three independent divisional hollow spaces by means of a freely displaceable piston, wherein at least one of these divisional hollow spaces is connected to a gas reservoir, and wherein at least two of the other divisional hollow spaces are respectively connected to at least one hydraulic unit of a spring element.

23. The spring suspension system of claim 21, wherein hydraulic units on opposite sides of a wheel axle are connected to a common gas reservoir by means of a synchronization unit.

24. The spring suspension system of claim 21, wherein the hydraulic units of the respective vehicle sides are connected via common lines, and the two lines of the respective vehicle sides are connected to a gas reservoir by means of a common synchronization unit.

25. The spring suspension system of claim 21, wherein two respective hydraulic units which are arranged on diagonally opposite wheels are connected to a common gas reservoir by means of one respective synchronization unit.

26. The spring suspension system of claim 21, wherein each hydraulic unit is provided with a gas reservoir.

27. The spring suspension system of claim 21, wherein the working volumes of the hydraulic units are respectively interconnected.
